(19) United States
(12) Patent Application Publication
(10) Pub. No.: US 2025/0196072 A1
(43) Pub. Date: Jun. 19, 2025

(54) POLY(QUINOLINE) MEMBRANES

(71) Applicant: ENTEGRIS, INC., Billerica, MA (US)

(72) Inventors: Zhifeng Li, Acton, MA (US); Sina Bonyadi, Billerica, MA (US); Pushkara Rao Varanasi, Poughkeepsie, NY (US)

(21) Appl. No.: 19/072,982

(22) Filed: Mar. 6, 2025

Related U.S. Application Data
(62) Division of application No. 17/840,394, filed on Jun. 14, 2022.
(60) Provisional application No. 63/210,667, filed on Jun. 15, 2021.

(51) Int. Cl. B01D 71/58; B01D 61/02; B01D 67/00; B01D 69/02; B01D 69/12

(52) U.S. Cl. CPC B01D 71/58; B01D 61/02; B01D 67/0011; B01D 67/0013; B01D 67/0016; B01D 69/02; B01D 69/12; B01D 2323/22; B01D 2325/02; B01D 2325/04

(57) ABSTRACT

In summary, the disclosure provides certain membranes useful as filter materials in the removal of metal ions, metal particulates, and/or organic contaminants from liquid compositions, in particular liquid compositions used in the microelectronic device industry. The membranes of the disclosure are porous membranes comprised of poly(quinoline) polymers. Advantageously, the poly(quinoline) membranes are thermally stable and hydrolytically stable and can thus be cleaned between uses using acidic material such as dilute hydrochloric acid, without suffering from significant degradation. The poly(quinoline) polymers can be designed to be soluble in certain solvents, thus enabling the manufacture of the corresponding porous membranes by immersion-casting techniques.

### CROSS-REFERENCE TO RELATED APPLICATIONS

This application is a divisional of U.S. patent application Ser. No. 17/840,394, filed Jun. 14, 2022, which claims the benefit under 35 USC 119 of U.S. Provisional Patent Application No. 63/210,667, filed Jun. 15, 2021, the disclosures of which are hereby incorporated herein by reference in their entirety.

### TECHNICAL FIELD

The disclosure relates generally to the field of liquid purification using membrane technology.

### BACKGROUND

Filter products are indispensable tools of modern industry, used to remove unwanted materials from a flow of a useful fluid. Useful fluids that are processed using filters include water, liquid industrial solvents and processing fluids, used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

Filters can remove unwanted materials by a variety of different ways, such as by size exclusion or by chemical and/or physical interaction with material. Some filters are defined by a structural material providing a porous architecture to the filter, and the filter is able to trap particles of a size that are not able to pass through the pores. Some filters are defined by the ability of the structural material of the filter, or of a chemistry associated with the structural material, to associate and interact with materials that pass over the filter. For example, chemical features of the filter may enable association with unwanted materials from a stream that passes over or through the filter, trapping those unwanted materials such as by ionic, coordinative, chelation, or hydrogen-bonding interactions. Some filters can utilize both size exclusion and chemical interaction features to remove materials from a filtered stream.

In some cases, to perform a filtration function, a filter includes a filter membrane that is responsible for removing unwanted material from a fluid that passes through. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

The removal of ionic materials such as dissolved anions or cations from solutions is important in many industries, such as the microelectronics industry, where ionic contaminants and particles in very small concentrations can adversely affect the quality and performance of microprocessors and memory devices. In particular, it may be desirable to remove metal-containing materials, including metal ions from liquid compositions that are used for device fabrication. Metal-containing materials can be found in different types of liquids that are used for microelectronic manufacturing.

There remain various unresolved technical challenges for the removal of metal-containing materials from liquid compositions. A large range of different types of liquid materials are used as process solvents, cleaning agents, and other processing solutions in microelectronic device processing. Many, if not most of these materials require a very high level of purity. As an example, liquid materials (e.g., solvents) used in photolithography processing of microelectronic devices must be of very high purity. Specific examples of liquids that are used in microelectronic device processing include process solutions for spin-on-glass (SOG) techniques, for bottom anti-reflective coating (BARC) methods, for photolithography, wet chemistry etching methods, and cleaning operations following chemical mechanical polishing, ashing, and etching methods

### BRIEF DESCRIPTION OF THE DRAWINGS

FIG. 1 is a scanning electron micrograph (SEM) of the membrane of Example 4 showing the porosity of the membrane cross-section at 800× magnification.

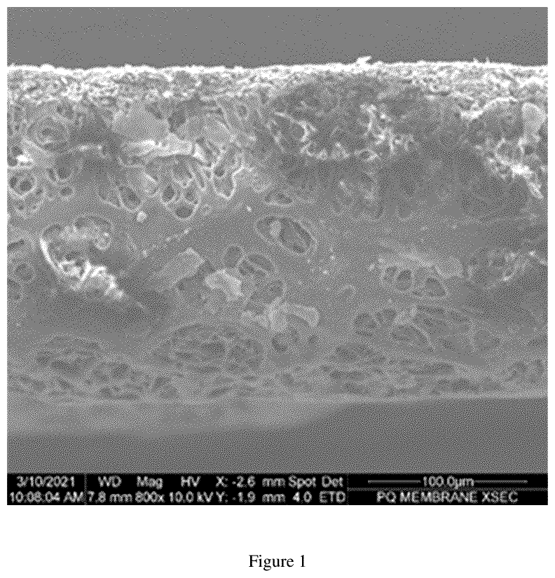

FIG. 2 is an SEM of the membrane of Example 4, showing the porosity of the surface of the membrane at 200× magnification.

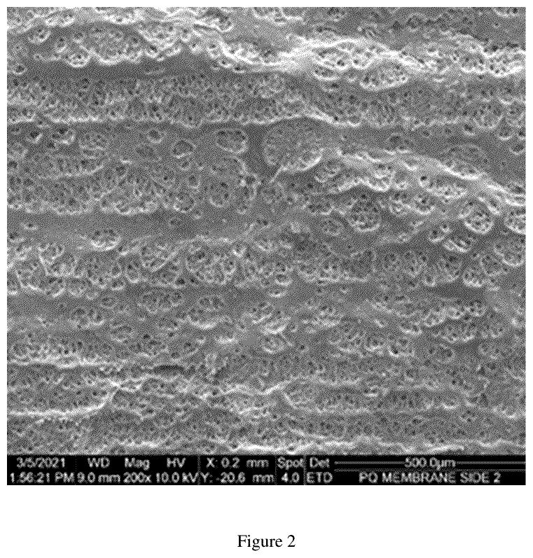

### SUMMARY

In summary, the disclosure provides certain membranes useful as filter materials in the removal of particulates, metal ions, and organic contaminants from liquid compositions, in particular liquid compositions used in the microelectronic device industry. The membranes of the disclosure are porous membranes comprised of poly(quinoline) polymers. The poly(quinoline) polymers have relatively high glass transition temperatures (T_{g}), i.e., about 200° C. to about 400° C. and have excellent thermal stability (i.e., from about 300° C. to 500° C.). Advantageously, the poly(quinoline) membranes are hydrolytically stable, and can thus be cleaned between uses using acidic wash materials such as dilute hydrochloric acid, without suffering undesired degradation. The poly(quinoline) polymers can be designed to be soluble in certain solvents, thus enabling the manufacture of the corresponding porous membranes by immersion-casting techniques.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

A filter membrane can be constructed of a porous structure that has average pore sizes that can be selected based on the use of the filter, i.e., the type of filtration performed by the filter. Typical pore sizes are in the micron or sub-micron range, such as from about 0.001 μm to about 10 μm. Membranes with average pore size of from about 0.001 μm to about 0.05 μm are sometimes classified as ultrafilter membranes. Membranes with pore sizes between about 0.05 μm and 10 μm are sometimes referred to as microporous membranes.

A filter membrane, or as referred to herein simply as a “membrane”, having micron or submicron range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

In certain embodiments of the filter membranes and methods of the present disclosure, the filter includes a porous filter membrane in the form of a polymeric film comprised of certain poly(quinoline)s. As used herein, a “porous filter membrane” is a porous polymeric solid that contains porous (e.g., microporous) interconnecting passages that extend from one surface of the membrane to an opposite surface of the membrane. The passages generally provide tortuous tunnels or paths through which a liquid being filtered must pass.

The filter membranes and methods of the disclosure can also function to prevent any particles (e.g., metal containing particles) present within the liquid composition that are larger than the pores from entering the microporous membrane or can function to trap the particles within the pores of the microporous membrane (i.e., wherein particles are removed by a sieving-type filtration mechanism).

Liquid compositions in need of purification can be passed through filter membranes of the disclosure to effectively remove metal contaminants and/or organic contaminants to levels suitable for a desired application. One application which can use the filter materials and methods of the disclosure is semiconductor manufacturing, such as for the purification of metals from solutions that are used for etching and cleaning semiconductor materials. Given the selectivity of their purification capabilities, the filter membranes and methods of the disclosure are particularly useful in photolithography in general. Advantageously, the filter membranes and methods of the disclosure are expected to effectively remove undesired amounts of particulate materials, such as metal particulate, ionic and/or organic contaminants from such fluids.

In one embodiment, metal contaminants to be removed using the filter materials and methods of the disclosure include Li, B, Na, K, Mg, Al, Ca, Ti, V, Cr, Mn, Fe, Ni, Cu, Zn, Mo, Cd, Sn, Ba, and Pb ions, either individually or in combinations of two or more thereof.

In one embodiment, the metal ions to be removed are chosen from iron, chromium, manganese, aluminum, and nickel cations.

Thus, in a first aspect, the disclosure provides a porous membrane comprising a poly(quinoline) polymer, the membrane having a thickness of about 40 μm to about 300 μm. In certain embodiments, the membrane has a mean pore size of about 10 nm to about 200 nm, or about 10 nm to about 100 nm. Typically, the poly(quinoline) polymers will have a number average molecular weight (Mₙ) of about 20,000 to about 200,000 Daltons. In certain embodiments, the poly(quinoline) polymers of the disclosure will have a glass transition temperature of about 250° C. to about 350° C.

In one embodiment, the poly(quinoline) polymer is comprised of moieties of the formula (I):

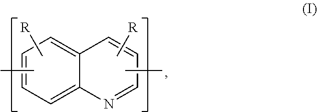

wherein each R is independently chosen from hydrogen, phenyl, substituted phenyl, thienyl or a C₁-C₆ alkyl group. In another embodiment, the poly(quinoline) polymer is comprised of moieties of the formula (II):

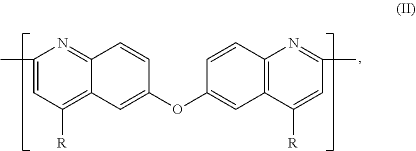

wherein each R is independently chosen from hydrogen, phenyl, thienyl (i.e., a thiophene group), substituted phenyl, or a C₁-C₆ alkyl group.

In another embodiment, the poly(quinoline) polymer is comprised of repeat units of the formula (III):

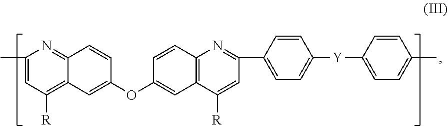

wherein Y is
   a. oxygen,
   b. a divalent ketone moiety of the formula:

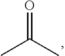

c. a divalent sulfone moiety of the formula:

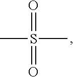

or
d. a divalent group of the formula

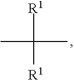

wherein each R is independently chosen from hydrogen, phenyl, thienyl (i.e., a thiophene group), substituted phenyl, or a C₁-C₆ alkyl group, and each R¹ is independently chosen from C₁-C₆ alkyl, or C₁-C₆ alkyl substituted one or more times with a fluorine atom.

The term “substituted phenyl” as used herein refers to phenyl groups having one or more substituents chosen from halogen; hydroxy; nitro; C₁-C₆ alkoxy; C₁-C₆ alkyl; and C₁-C₆ alkyl substituted one or more times with a group chosen from halogen, hydroxy, or nitro.

In one embodiment, R is phenyl. In another embodiment, —Y— is a divalent group of the formula

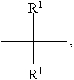

and each of R¹ is trifluoromethyl.

In certain embodiments, the material of the filter membrane can have a chemistry suitable for attachment of a functionality of chelation or ion exchange. This functionality may be introduced via a coating which can be applied to the membrane, such coating possessing suitable functional groups for chelation and/or ion exchange mechanisms for the removal of impurities. Alternatively, the “R” groups above in Formulae (I), (II), and (III), can be altered to contain such a functional group which can then be available for non-sieving purification mechanisms without the application of a coating or other surface treatment on the membrane, such as a sulfonic acid group or other group used in ion exchange purification methods. Examples of various methodologies for grafting or otherwise attaching desired functional groups to the polymer membrane surface for the purpose of non-sieving filtration can be found in U.S. Pat. No. 10,792,620, incorporated herein by reference, and in U.S. Patent Publication Nos. 2020/0406201; 2020/0254398; 2020/0206691; 2019/0329185; and 2018/0185835, incorporated herein by reference.

The poly(quinolines) useful in this disclosure can be prepared by known synthetic methodologies. In this regard, see U.S. Pat. Nos. 5,786,071; 5,247,050; 5,648,448; and 6,462,148, incorporated herein by reference, and Hong Ma, et al., Chem. Mater. 1999, 11, 2218-2225.

In one example, the poly(quinolines) of the disclosure as set forth above in formula (III), wherein each R is phenyl, Y is a group of the formula

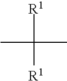

and each R′ is trifluoromethyl. i.e., the polymer comprised of repeat units of the formula:

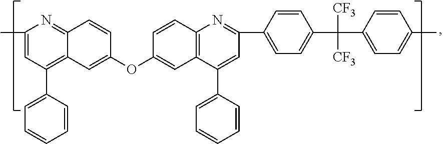

can be prepared by the co-polymerization of a monomer of the formula (A):

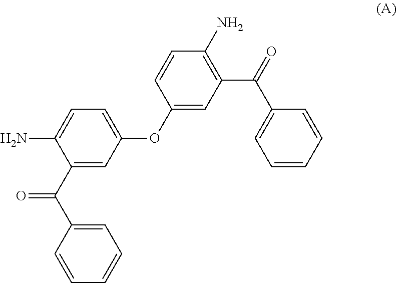 [SMILES: Nc1ccc(Oc2ccc(N)c(C(=O)c3ccccc3)c2)cc1C(=O)c1ccccc1]

and a monomer of the formula (B):

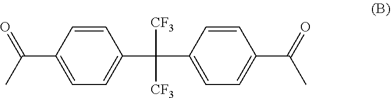 [SMILES: CC(=O)c1ccc(C(c2ccc(C(C)=O)cc2)(C(F)(F)F)C(F)(F)F)cc1]

at an elevated temperature, in the presence of diphenyl phosphate, in a solvent such as m-cresol.

The monomer of formula (A) can be prepared in two steps from the reaction of phenylacetonitrile and 4,4′-dinitrophenyl ether in the presence of sodium hydroxide, to form an intermediate of the formula (C):

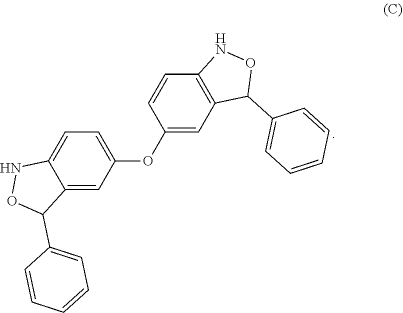 [SMILES: c1ccc(C2ONc3ccc(Oc4ccc5c(c4)C(c4ccccc4)ON5)cc32)cc1]

The compound of formula (C) can then be hydrogenated, for example in the presence of a catalyst such as Pd/C, in tetrahydrofuran, to provide the compound of formula (A) above.

The compound of formula (B), i.e., 2,2-di(4-acetylphenyl)hexafluoropropane, can be prepared by reacting 2,2-di(4-carboxyphenyl)hexafluoropropane with methyllithium in tetrahydrofuran, followed by hydrolysis with hydrochloric acid.

As noted above, the membranes disclosed herein may be prepared by an immersion casting process. In this process, the poly(quinoline) is dissolved in a water-miscible solvent. Suitable solvents for a particular poly(quinoline) for this purpose can either be determined using the Hansen Solubility Parameters analysis or can be determined empirically, by trial and error. In certain embodiments, such solvents include the water-miscible solvents, such as tetrahydrofuran, N-methyl pyrrolidone (NMP), N,N-dimethylformamide (DMF), dimethylacetamide (DMAC), dimethylsulfoxide (DMSO), dioxane, or tetrahydropyran. Polymer nonsolvents are another class of materials that are commonly added to the polymer solution to change its phase separation behavior and result in a desired membrane morphology. Liquids such as water and certain water-miscible organic materials can be used as nonsolvents in this membrane formation, alone, as a combination of nonsolvents, or utilized sequentially. Once in solution, these polymer solutions can be cast into a film and immersed into a nonsolvent/coagulant to induce phase separation and form the porous membranes of the disclosure.

In one embodiment, the water-miscible nonsolvent materials include C₁-C₁₀ alkanols, such as methanol, ethanol, n-propanol, isopropanol, n-butanol, sec-butanol, tert-butanol, and the like. Additionally, the non-solvent can be chosen from glycols and glycol ethers, C₂-C₁₀ diols and C₂-C₁₀ triols, tetrahydrofurfuryl alcohol, ethyl benzoate, acetonitrile, acetone, ethylene glycol, propylene glycol, 1,3-propanediol, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, propylene glycol phenyl ether, ethylene glycol monophenyl ether, diethylene glycol monophenyl ether hexaethylene glycol monophenylether, dipropylene glycol methyl ether acetate, tetraethylene glycol dimethyl ether dibasic ester, glycerine carbonate, N-formyl morpholine, triethyl phosphate, and combinations thereof.

In the addition of the nonsolvent(s), the formation of the membrane (i.e., film) morphology is taken into consideration in the determination of the desired microstructure, in terms of porosity, average pore size as well as pore size distribution. The desired morphology is thus provided via both by choice of nonsolvent(s), concentration, temperature, etc. In one embodiment, a poly(quinoline) polymer is dissolved in tetrahydrofuran, blended with isopropanol, cast into a film and then immersed in water to induce this phase separation and formation of a porous filter membrane (i.e., film).

Thus, in a further aspect, the disclosure provides a porous membrane comprising a poly(quinoline) polymer, the membrane having
a thickness of about 40 μm to about 300 μm,
a mean pore size of about 10 nm to about 200 nm,
prepared by dissolving the poly(quinoline) polymer in a water-miscible solvent to form a solution, followed by addition of at least one first nonsolvent,
followed by casting the solution over a flat surface, thereby forming a coated surface, followed by immersion of the coated surface in at least one second nonsolvent, thereby effecting formation of the porous membrane.

In one embodiment of this aspect, the membrane exhibits an isopropanol flow time of greater than about 200 seconds/500 ml and less than about 50,000 seconds/500 ml, when measured at 14.2 psi, and a bubble point of about 5 to about 400 psi, when measured using ethoxynonafluorobutane HFE 7200 at a temperature of about 22° C.,

In another embodiment, the bubble point is about 5 to about 180 psi, when measured using ethoxynonafluorobutane HFE 7200 at a temperature of about 22° C.

In one embodiment, the first nonsolvent is isopropanol and the second nonsolvent is water.

In another embodiment, the solution of the poly(quinoline) referred to above, may be subjected to filtration through an ion exchange resin or membrane in order to remove trace amounts of metal ions which may be entrained within the poly(quinoline) starting material. For example, a tetrahydrofuran solution of poly(quinoline) may be passed through an ion exchange membrane or column containing ion exchange resin beads to remove trace amounts of metal ions prior to the formation of the membranes of the disclosure.

As used herein, a “filter,” refers to an article having a structure that includes a filter membrane.

In some embodiments, the filter of the disclosure includes a composite filter arrangement. For example, a filter with a composite arrangement can include two or more filter materials, such as two or more filter articles. For example, the filter can include a first porous polymeric membrane that includes the membrane(s) of the present disclosure, and a second filter material that does not include the membrane(s) of the present disclosure, or that is in some way different from the membrane(s) of the present disclosure. The second filter material can also be in the form of a porous membrane, or can be different, such as having a non-porous form, or other filter material, such as a woven or nonwoven material. The second filter material can be made of the same or of a different polymeric material than the first membrane.

Accordingly, in another aspect, the disclosure provides a composite filter comprising:
a first filter material and a second filter material, an output facing surface of the first filter material in contact with an input facing surface of the second filter material,
wherein the first filter material comprises the membrane of the disclosure as set forth herein;
and wherein the second filter material is different from the first filter material.

As noted above, the filter membranes can be used to remove particulate materials (such as metal particles), and metal ions, or organic contaminants from a liquid composition such as an organic solvent. Some specific, non-limiting, examples of solvents used in photolithography which can be filtered using a filter membrane as described herein include: n-butyl acetate (nBA), isopropyl alcohol (IPA), 2-ethoxyethyl acetate (2EEA), cyclohexanone, ethyl lactate, gamma butyro lactone, isopentyl ether, methyl-2-hydroxyisobutyrate, methyl isobutyl carbinol (MIBC), methyl isobutyl ketone (MIBK), isoamyl acetate, propylene glycol methyl ether (PGME), propylene glycol monomethyl ether acetate (PGMEA), and a mixed solution of propylene glycol monomethyl ether (PGME) and PGMEA (7:3) (i.e., OK73 solvent) mixing ratio surface tension of 27.7 mN/m).

For example, in some modes of practice, a solvent may be obtained having an amount of metal ion and/or metal containing impurities (i.e., particulates), and or organic contaminants, that are higher than desired for a target application, such as cleaning solvents, or solvents for resist stripping applications in lithography, for formation of an integrated circuit. For example, the metal impurities can be present in total amounts at ppm or ppb levels in the solvent. The solvent is then passed through the filter membranes of the disclosure to remove metal contaminants and to provide a filtered solvent having a concentration or amount of metals that is lower than the amount of metals in the starting solvent. In certain modes of practice the filter membrane of the disclosure can remove an amount of about 25% (wt) or greater, about 30% (wt) or greater, about 35% (wt) or greater, about 40% (wt) or greater, about 45% (wt) or greater, about 50% (wt) or greater, about 55% (wt) or greater, about 60% (wt) or greater, about 65% (wt) or greater, about 70% (wt) or greater, about 75% (wt) or greater, about 80% (wt) or greater, about 85% (wt) or greater, about 90% (wt) or greater, or about 95% (wt) or greater, any one or more metals from the starting solvent.

The solvents that are treated to remove metal contaminants can be passed through the filters under desired conditions, such as those that enhance removal of metal contaminant from the fluid stream. In some modes of practice, the solvent is passed through the filter at a temperature of about 120° C. or less, 80° C. or less, or 40° C. or less.

The passage of solvent through the filter membranes of the disclosure is not limited to any particular flow rate.

Referring to the porous polymeric filter membranes as described herein, such membranes can be characterized by physical features that include pore size, bubble point, and porosity. In this regard, the porous polymeric filter membrane may have any pore size that will allow the filter membrane to be effective for performing as a filter membrane, e.g., as described herein, including pores of a size (average pore size) sometimes considered as a microporous filter membrane or an ultrafilter membrane. In certain embodiments, the porous membranes can have an average pore size in a range on from about 10 nm to about 200 nm, or about 10 nm to about 100 nm, with the pore size to be selected based on one or more factors that include: the particle size or type of impurity to be removed, pressure and pressure drop requirements, and viscosity requirements of a liquid being processed by the filter. Pore size is often reported as average pore size of a porous material, which can be measured by known techniques such as by Mercury Porosimetry (MP), Scanning Electron Microscopy (SEM), Liquid Displacement (LLDP), or Atomic Force Microscopy (AFM).

Bubble point is also a known feature of a porous membrane. By a bubble point test method, a sample of porous polymeric filter membrane is immersed in and wetted with a liquid having a known surface tension, and a gas pressure is applied to one side of the sample. The gas pressure is gradually increased. The minimum pressure at which the gas flows through the sample is called a bubble point. To determine the bubble point of a porous material a sample of the porous material is immersed in and wetted with ethoxy-nonafluorobutane HFE 7200 (available from 3M) at a temperature of 20-25° C. (e.g., 22° C.). A gas pressure is applied to one side of the sample (the side of the membrane sample having the larger pore sizes) by using compressed air and the gas pressure is gradually increased. When the membrane is asymmetric, the gas pressure is applied to the side of the membrane sample having the larger pore size. All bubble point values provided herein are measured using the procedure described above and are initial bubble points unless otherwise noted. Examples of useful bubble points of a porous polymeric filter membrane that is useful or preferred according to the present description, measured using the procedure described above can be in a range from about 5 to about 400 psi, about 5 to about 350 psi, about 5 to about 300 psi, about 5 to about 250 psi, about 5 to about 225 psi, about 5 to about 200 psi, about 5 to about 180 psi, about 5 to about 150 psi, about 30 to about 400 psi, about 30 to about 350 psi about 30 to about 300 psi, about 30 to about 250 psi, about 30 to about 225 psi, about 30 to about 200 psi, about 30 to about 180 psi, about 30 to about 150 psi, about 50 to about 400 psi, about 50 to about 350 psi about 50 to about 300 psi, about 50 to about 250 psi, about 50 to about 225 psi, about 50 to about 200 psi, about 50 to about 180 psi, and all ranges and subranges therebetween. A porous polymer filter layer as described may have any porosity that will allow the porous polymer filter layer to be effective as described herein. Example porous polymer filter layers can have a relatively high porosity, for example a porosity of at least 60, 70 or 80 percent. As used herein, and in the art of porous bodies, a “porosity” of a porous body (also sometimes referred to as void fraction) is a measure of the void (i.e., “empty”) space in the body as a percent of the total volume of the body, and is calculated as a fraction of the volume of voids of the body over the total volume of the body. A body that has zero percent porosity is completely solid.

Advantageously, the bubble point and IPA flow time (affected by pore size and interconnectivity, i.e., morphology) balance are optimized for desired overall performance.

A porous polymeric filter membrane as described can be in the form of a sheet or hollow fiber having any useful thickness, e.g., a thickness in a range from about 40 μm to about 300 μm, about 80 μm to about 250 μm, or about 120 μm to about 200 μm, or about 140 μm to 180 μm.

In certain embodiments, the membranes of the disclosure are asymmetric.

Membrane isopropanol (IPA) flow times as reported herein are determined by measuring the time it takes for 500 ml of isopropyl alcohol fluid to pass through a membrane with a 47 mm membrane disc with an effective surface area of 13.8 cm², at 14.2 psi, and at a temperature of 21° C.

A filter membrane as described can be contained within a larger filter structure such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid chemical to cause at least a portion of the flow of the liquid chemical to pass through the filter membrane, so that the filter membrane removes an amount of the impurities or contaminants from the liquid chemical. The structure of a multi-layer filter assembly or filter cartridge may include one or more of various additional materials and structures that support the filter membrane within the filter assembly or filter cartridge to cause fluid to flow from a filter inlet, through the membrane (including the filter layer), and thorough a filter outlet, thereby passing through the filter membrane when passing through the filter. As noted above, the filter membrane supported by the filter assembly or filter cartridge can be in any useful shape, e.g., a pleated cylinder, a cylindrical pad, one or more non-pleated (flat) cylindrical sheets, a pleated sheet, among others.

In addition, a filter membrane as described can be characterized by membrane flux, which is defined as the volumetric flow of a liquid going through the unit area of the membrane at a certain pressure. The membrane flux must be sufficiently high so that a membrane filter device having certain membrane area can deliver the required flow rate of the liquid for a certain application. The flow characteristic of a membrane can also be measured by membrane flow-time which can be considered as membrane resistance toward the liquid flow and is defined as the time required for the flow of 500 ml of liquid through a 47 mm disc membrane with an effective surface area of 13.8 cm² at a pressure of 14.2 psi, at 21° C. A filter membrane as described herein can in certain embodiments have a relatively low flow time, for example in combination with a bubble point that is relatively high, and exhibit good filtering performance (e.g., as measured by particle retention). In some embodiments, the isopropanol flow time is greater than about 200 seconds/500 mL, when measured at 14.2 psi. In other embodiments, the isopropanol flow time is In other embodiments, the isopropanol flow time is greater than about 200 seconds/500 mL and below about 50,000 seconds/500 mL, greater than about 200 seconds/500 mL and below about 20,000 seconds/500 mL, greater than about 200 seconds/500 mL and below about 15,000seconds/500 mL, greater than about 200 seconds/500 mL and below about 8, 000 seconds/500 mL, greater than about 200 seconds/500 mL and below about 1,000 seconds/500 mL, greater than about 500 seconds/500mL and below about 50,000 seconds/500 mL, greater than about 500 seconds/500 mL and below about 20,000 seconds/500 mL, greater than about 500 seconds/500 mL and below about 15,000 seconds/500 mL, greater than about 200 seconds/500 mL and below about 8,000seconds/500 mL, greater than about 500 seconds/500 mL and below about 1,000 seconds/500 mL, greater than about 1,000 seconds/500 mL and below about 50,000 seconds/500 mL, greater than about 1,000 seconds/500 mL and below about 20,000 seconds/500 mL, greater than about 1,000 seconds/500 mL and below about 15,000 seconds/500 mL, than about 200 seconds/500 mL and below about 8, 000 seconds/500 mL, and any ranges and subranges therebetween. when measured at 14.2 psi.

Accordingly, in a further aspect, the disclosure provides a method of removing one or more particulate materials and/or metal ions and/or organic contaminants from a liquid composition, said liquid composition comprising at least one particulate material, and/or metal ion, the method comprising:
(i) passing the liquid composition through the membrane of the disclosure, and
(ii) reducing an amount of the one or more particulate materials, and/or metal ions and/or organic contaminants in the liquid composition, thereby providing a purified liquid composition.

### EXAMPLES

### Example 1—5,5′-Oxybis(phenyl-2,1-benzisoxazole) (2a)

To a vigorously stirred solution of sodium hydroxide (21.60 g, 0.54 mol) in 120 mL of absolute methanol and 340 mL of tetrahydrofuran (THF) in an ice bath was added dropwise phenylacetonitrile (27.4 mL, 29.70 g, 0.20 mol). Then, 4,4′-dinitrodiphenyl ether (13.00 g, 0.05 mol) was slowly added with four equal portions, and the mixture was stirred in an ice bath for 5 min. The resulting dark green slurry was heated at reflux temperature for 20 h. After cooling in an ice bath, the resulting dark precipitate was filtered and washed with cold methanol until the methanol washings were clear to afford a yellow powder (12.60 g, 54%).

### Example 2—4,4′-Diamino-3,3′-di(benzoyl)diphenyl Ether (2)

A total of 0.56 g of 10% palladium on powdered charcoal was added to a suspension of the compound of formula (C) above (4.00 g, 8.60 mmol) in 35 mL of dry THF and 1.0 mL of triethylamine. The suspension was flushed with hydrogen gas and stirred at room temperature under a hydrogen atmosphere for 27 h. To the reaction mixture was added an additional 0.28 g of 10% palladium on powdered charcoal in 10 mL of THF, and the hydrogenation was continued for another 14 h. The catalyst was removed by filtration, and the solvent was removed by rotatory evaporation under reduced pressure. The resulting oil was purified through a packed silica gel column with hexane/ethyl acetate (1:1) as eluant to afford a yellow crystal (2.80 g, 70%).

### Example 3—Synthesis of Representative poly(quinoline) Polymer

A mixture of the compound of formula (A) above, (2.00 mmol), a compound of formula (B) above, (2.00 mmol), diphenyl phosphate (DPP) (12.51 g, 50.0 mmol), and freshly distilled m-cresol (2.40 mL, 23.0 mmol) was placed in a three-necked flask. With the stirring, the reaction mixture was flushed with nitrogen for about 20 min and then heated in an oil bath from room temperature to 135-140° C. in about 30 min. It was maintained at this temperature for 48 h under a nitrogen atmosphere.

After cooling, the resulting viscous solution was added dropwise into an agitated solution of 400 mL of methanol containing 10% v/v of triethylamine. The precipitated polymer was redissolved in 30 mL of chloroform or tetrahydrofuran and reprecipitated by slow addition to a stirred solution of 400 mL of methanol containing 10% v/v of triethylamine. The polymer was collected by suction filtration and continuously extracted in a Soxhlet extractor for 24 h with a methanol solution containing 10% v/v of triethylamine and then dried at 100° C. under vacuum for 24 h to afford an off-white polymer with 96% yield (1.51 g).

### Example 4—Preparation of a Filter Membrane

A 6.8 g sample of a poly(quinoline) (PQ) polymer prepared generally in the manner of Example 3, in powder form was added to 50 g of tetrahydrofuran (THF) solvent under stirring by an overhead stirrer. After the polymer was fully dissolved, 15.5 g of isopropanol (IPA) was added to the solution as a nonsolvent. PQ membranes were made by casting a thin film of the polymer solution with a thickness of around 150-200 microns on a glass and subsequently immersing it into a bath of water at room temperature. The formed membrane was dried at room temperature for 24 hours. Then the membrane the IPA flow time and bubble point were measured, with the result of IPA flow-time and bubble point shown in the table below.

| Material Ratio by | | Initial Bubble | ASTM average |
|---|---|---|---|
| weight | IPA flow time | Point | bubble point (psi) |
| *PQ/THF/IPA = | 780 seconds/ | 3.57 psi | 12.6 psi |
| 6.8/50/15.5 | 500 ml | | |

### Aspects

In a first aspect, the disclosure provides a porous membrane comprising a poly(quinoline) polymer, the membrane having a thickness of about 40 μm to about 300 μm.

In a second aspect, the disclosure provides the membrane of the first aspect, wherein the membrane exhibits a bubble point of about 5 to about 400 psi, when measured using ethoxynonafluorobutane HFE 7200 at a temperature of about 22° C.

In a third aspect, the disclosure provides the membrane of the first or second aspect, wherein the membrane has a mean pore size of about 10 to about 200 nm.

In a fourth aspect, the disclosure provides the membrane of any one of the first through the third aspects, wherein the poly(quinoline) polymer is comprised of moieties of the formula:

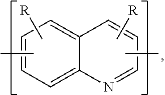

wherein each R is independently chosen from hydrogen, phenyl, substituted phenyl, thienyl, or a C₁-C₆ alkyl group.

In a fifth aspect, the disclosure provides the membrane of any one of the first through fourth aspects, wherein the poly(quinoline) polymer is comprised of moieties of the formula:

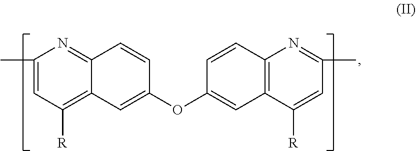

wherein each R is independently chosen from hydrogen, phenyl, thienyl, substituted phenyl, or a C₁-C₆ alkyl group.

In a sixth aspect, the disclosure provides the membrane of the fifth or sixth aspects, wherein each R is hydrogen.

In a seventh aspect, the disclosure provides the membrane of the fifth or sixth aspects, wherein one R is hydrogen and the other R is phenyl.

In an eighth aspect, the disclosure provides the membrane of any one of the first through the seventh aspects, wherein the poly(quinoline) polymer is comprised of repeat units of the formula (III):

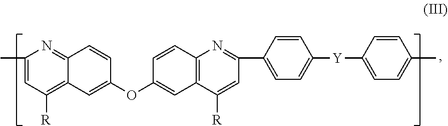

wherein Y is chosen from:
   a. oxygen,
   b. a divalent ketone moiety of the formula:

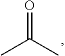

c. a divalent sulfone moiety of the formula

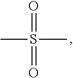

or
d. a divalent group of the formula

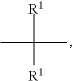

wherein each R is independently chosen from hydrogen, phenyl, thienyl, substituted phenyl, or a C₁-C₆ alkyl group, and R¹ is independently chosen from C₁-C₆ alkyl, or C₁-C₆ alkyl substituted one or more times with a fluorine atom.

In a ninth aspect, the disclosure provides the membrane of the eighth aspect, wherein R is phenyl.

In a tenth aspect, the disclosure provides the membrane of the eighth or ninth aspects, wherein Y is a group of the formula

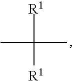

and each R¹ is trifluoromethyl.

In an eleventh aspect, the disclosure provides the membrane of any one of the first through the tenth aspects, wherein the membrane exhibits an isopropanol flow time of greater than about 200 seconds/500 ml and less than about 50,000 seconds/500 ml, when measured at 14.2 psi, and a bubble point of about 5 to about 300 psi, when measured using ethoxynonafluorobutane HFE 7200 at a temperature of about 22° C.

In a twelfth aspect, the disclosure provides a porous membrane comprising a poly(quinoline) polymer, the membrane having
a thickness of about 40 μm to about 300 μm, and
a mean pore size of about 10 nm to about 200 nm,
prepared by dissolving the polymer in a water-miscible solvent to form a solution, followed by addition of at least one first nonsolvent, followed by casting the solution over a flat surface, thereby forming a coated surface, followed by immersion of the coated surface in at least one second nonsolvent, thereby effecting formation of the porous membrane.

In a thirteenth aspect, the disclosure provides the membrane of the twelfth aspect, wherein the membrane wherein the membrane exhibits an isopropanol flow time of greater than about 200 seconds/500 ml and less than about 50,000 seconds/500 ml, when measured at 14.2 psi, and a bubble point of about 5 to about 400 psi, when measured using ethoxynonafluorobutane HFE 7200 at a temperature of about 22° C.

In a fourteenth aspect, the disclosure provides the membrane of the twelfth or thirteenth aspects, further comprising the step of purifying the solution by filtration through an ion-exchange resin or membrane, thereby removing trace metal ion contaminants, prior to casting the solution over a flat surface.

In a fifteenth aspect, the disclosure provides the membrane of any one of the twelfth through fourteenth aspects, wherein the first nonsolvent comprises isopropanol.

In a sixteenth aspect, the disclosure provides the membrane of any one of the twelfth through fifteenth aspects, wherein the second nonsolvent comprises water.

In a seventeenth aspect, the disclosure provides the membrane of any one of the twelfth through sixteenth aspects, wherein the water-miscible solvent is chosen from tetrahydrofuran, N-methyl pyrrolidone, N,N-dimethylformamide, dimethylacetamide, dimethylsulfoxide, dioxane, or tetrahydropyran.

In an eighteenth aspect, the disclosure provides the membrane of any one of the twelfth through seventeenth aspects, wherein the water-miscible solvent comprises tetrahydrofuran.

In a nineteenth aspect, the disclosure provides a method of removing one or more particulate materials and/or metal ions and/or organic contaminants from a liquid composition, said liquid composition comprising at least one particulate material, and/or metal ion, and/or organic contaminant, the method comprising:
(i) passing the liquid composition through the membrane of any one of claims 1 through 18, and
(ii) reducing an amount of the one or more particulate materials, and/or metal ions and/or organic contaminants in the liquid composition, thereby providing a purified liquid composition.

In a twentieth aspect, the disclosure provides the method of the nineteenth aspect, wherein the liquid composition comprises a solvent chosen from n-butyl acetate, isopropyl alcohol, 2-ethoxyethyl acetate, cyclohexanone, ethyl lactate, gamma butyro lactone, isopentyl ether, methyl-2-hydroxyisobutyrate, methyl isobutyl carbinol, methyl isobutyl ketone, isoamyl acetate, propylene glycol methyl ether, propylene glycol monomethyl ether acetate, propylene glycol monomethyl ether, propylene glycol methyl ether acetate, and combinations thereof.

In a twenty-first aspect, the disclosure provides a filter comprising the membrane of any one of the first through eighteenth aspects.

In a twenty-second aspect, the disclosure provides a composite filter comprising:
a first filter material and a second filter material, an output facing surface of the first filter material in contact with an input facing surface of the second filter material,
wherein the first filter material comprises the membrane of any one of claims 1 to 18,
and the wherein second filter material is different from the first filter material.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A porous filter membrane having a thickness of about 40 μm to about 300 μm and comprising a poly(quinoline) polymer having repeat units of: 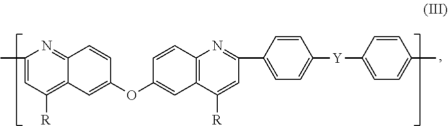
wherein Y is chosen from:
a. oxygen
b. a divalent ketone moiety of the formula: 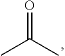
c. a divalent sulfone moiety of the formula 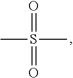
or
d. a divalent group of the formula 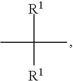
wherein each R is independently chosen from hydrogen, phenyl, thienyl, substituted phenyl, or a C1-C6 alkyl group, and R1 is independently chosen from C1-C6 alkyl, or C1-C6 alkyl substituted one or more times with a fluorine atom.

2. The porous membrane of claim 1, wherein the porous filter membrane exhibits a bubble point of about 5 psi to about 400 psi, when measured using ethoxynonafluorobutane HFE 7200 at a temperature of about 22° C.

3. The porous filter membrane of claim 1, wherein R is phenyl.

4. The porous filter membrane of claim 1, wherein Y is a group of the formula 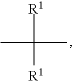
and each R¹ is trifluoromethyl.

5. The porous filter membrane of claim 1, wherein the membrane exhibits an isopropanol flow time of greater than about 200 seconds/500 ml and less than about 50,000 seconds/500 ml, when measured at 14.2 psi, and a bubble point of about 5 psi to about 300 psi, when measured using ethoxynonafluorobutane HFE 7200 at a temperature of about 22° C.

6. A filter comprising the porous filter membrane of claim 1.

7. A composite filter comprising:
a first filter material and a second filter material, an output facing surface of the first filter material in contact with an input facing surface of the second filter material,
wherein the first filter material is the porous filter membrane of claim 1,
and wherein the second filter material is different from the first filter material.

8. A method of removing one or more particulate materials and/or metal ions and/or organic contaminants from a liquid composition, said liquid composition comprising at least one particulate material, and/or metal ion, and/or organic contaminant, the method comprising:
(i) passing the liquid composition through the porous filter membrane of claim 1, and
(ii) reducing an amount of the one or more particulate materials, and/or metal ions and/or organic contaminants in the liquid composition, thereby providing a purified liquid composition.

9. The method of claim 8, wherein the liquid composition comprises a solvent chosen from n-butyl acetate, isopropyl alcohol, 2-ethoxyethyl acetate, cyclohexanone, ethyl lactate, gamma butyro lactone, isopentyl ether, methyl-2-hydroxyisobutyrate, methyl isobutyl carbinol, methyl isobutyl ketone, isoamyl acetate, propylene glycol methyl ether, propylene glycol monomethyl ether acetate, propylene glycol monomethyl ether, propylene glycol methyl ether acetate, and combinations thereof.
